(19) United States
(12) Patent Application Publication
(10) Pub. No.: US 2006/0092951 A1
(43) Pub. Date: May 4, 2006

(54) Information relaying method, apparatus and/or computer program product

(76) Inventors: B. David Peak, Auburn, AL (US); F. Daniel Peak, Columbus, GA (US); John R. Peak, Columbus, GA (US); John B. Grot, Midland, GA (US)

Correspondence Address: LITMAN LAW OFFICES, LTD, PO BOX 15035, CRYSTAL CITY STATION, ARLINGTON, VA, 22215, US

(21) Appl. No.: 11/207,946

(22) Filed: Aug. 22, 2005

Related U.S. Application Data
(60) Provisional application No. 60/617,208, filed on Oct. 12, 2004.
(60) Provisional application No. 60/638,487, filed on Dec. 27, 2004.
(60) Provisional application No. 60/643,999, filed on Jan. 18, 2005.

(51) Int. Cl. H04L 12/56

(52) U.S. Cl. 370/397

(57) ABSTRACT

An information relaying method, apparatus, and/or computer program product for relaying contact information between individuals. The information relaying method, apparatus, and/or computer program product establishes a communication link between the user of the information relaying apparatus and a user of another information relaying apparatus; selects at least one mode selected from the group consisting of a personal contact mode, a business contact mode, a confidential contact mode, a rejection/denial contact mode, a number transfer contact mode, a business stationary contact mode, and an off mode to operate the information relaying apparatus of the user; operates the information relaying apparatuses of the user according to the selected at least one mode; and relays contact information over the established communication link between the user of the information relaying apparatus and the other user of an information relaying apparatus according to the associated selected at least one mode.

### CROSS-REFERENCE TO RELATED APPLICATIONS

This application claims the benefit of U.S. Provisional Patent Application Ser. No. 60/617,208, filed Oct. 12, 2004, U.S. Provisional Patent Application Ser. No. 60/638,487, filed Dec. 27, 2004, and U.S. Provisional Patent Application Ser. No. 60/643,999, filed Jan. 18, 2005, which are each incorporated herein by reference.

### BACKGROUND OF THE INVENTION

1. Field of the Invention

The present invention relates generally to personal/business card contact information and, more particularly, to an information relaying method, apparatus, and/or computer program product for relaying personal, business, confidential, rejection/denial, number transfer, and/or business stationary contact information between individuals.

2. Description of the Related Art

The transfer of business cards during personal interactions between individuals during business or personal meetings is old and well known to provide contact information such as names, contact numbers, email addresses, etc. With the tremendous advancement of computer and wireless technology over the past several years, it would be highly desirable to shift from the use of business or personal cards with contact information to the use of wireless technology to transfer contact information between individuals.

Therefore, a need exists for an information relaying method, apparatus, and/or computer program product for relaying personal, business, confidential, rejection/denial, number transfer, and/or business stationary contact information.

### SUMMARY OF THE INVENTION

The present invention is a an information relaying method, apparatus, and/or computer program product for relaying personal, business, and/or contact information between individuals. The information relaying method provides an information relaying website, information relaying software, and an information relaying database; and provides information relaying apparatuses to users. The method establishes communication links between particular users of the information relaying apparatuses; selects at least one mode selected from the group consisting of a personal contact mode, a business contact mode, a confidential contact mode, a rejection/denial contact mode, a number transfer contact mode, a business stationary contact mode, and an off mode to operate the information relaying apparatuses of the particular users; operates the information relaying apparatuses of the particular users according to the associated selected at least one mode; and relays contact information over the established communication links between the particular users of the information relaying apparatuses according to the associated selected at least one mode.

The information relaying apparatus for relaying contact information between individuals includes a power source, memory with information relaying software embodied therein, a processor, a clock, at least one sensor, at least one transceiver, an antenna, and a communication bus electrically interconnecting the power source, memory, the processor, the clock, the at least one sensor, the at least one transceiver, and the antenna. The information relaying software, when executed by the processor, causes the processor to establish a communication link between the user of the information relaying apparatus and a user of another information relaying apparatus; select at least one mode selected from the group consisting of a personal contact mode, a business contact mode, a confidential contact mode, a rejection/denial contact mode, a number transfer contact mode, a business stationary contact mode, and an off mode to operate the information relaying apparatus of the user; operate the information relaying apparatuses of the user according to the selected at least one mode; and relay contact information over the established communication link between the user of the information relaying apparatus and the other user of an information relaying apparatus according to the associated selected at least one mode.

### BRIEF DESCRIPTION OF THE DRAWINGS

FIG. 1 is a diagram of arrangement for carrying out an information relaying method according to the present invention.

FIG. 2 is a diagram of a computer device configured for use with an information relying apparatus according to the present invention.

FIG. 3 is an environmental view of a business meeting between two individuals wearing information relaying apparatuses configured as wristbands according to the present invention.

FIG. 4A shows two information relaying apparatuses configured as wristbands wirelessly intercommunicating with each other according to the present invention.

FIG. 4B shows two information relaying apparatuses configured as wristbands wirelessly intercommunicating with each other during a handshake according to the present invention.

FIG. 5 is a block diagram of an information relaying apparatus according to the present invention.

FIGS. 6A and 6B are a diagram of information relaying software modules according to the present invention.

FIG. 7A is an information relaying apparatus configured as a watch according to the present invention.

FIG. 7B is an information relaying apparatus configured as a ring according to the present invention.

FIG. 7C is an information relaying apparatus configured as a bracelet according to the present invention.

FIG. 7D is an information relaying apparatus configured as a necklace according to the present invention.

FIG. 7E is an information relaying apparatus configured as an earring according to the present invention.

FIG. 7F is an information relaying apparatus configured as a pendant according to the present invention.

FIG. 7G is an information relaying apparatus configured as an eyeglass frame according to the present invention.

FIG. 7H is an information relaying apparatus configured as an earplug according to the present invention.

FIG. 8 is a diagram of an information relaying kit according to the present invention

FIG. 9 is an information relaying system group according to the present invention.

FIG. 10 is a stand-alone all purpose information relaying device according to the present invention.

FIG. 11 is a stand-alone all-purpose information relaying device kit according to the present invention.

FIG. 12 is a mobile communications device compatible information relaying software CD according to the present invention.

FIG. 13 is an indoor business stationary information relaying device according to the present invention.

FIG. 14 is an indoor business stationary information relaying device kit according to the present invention.

FIG. 15 is an outdoor business stationary information relaying device according to the present invention.

FIG. 16 is an outdoor business stationary information relaying device kit according to the present invention.

FIG. 17 is a business stand-alone information relaying device kit according to the present invention.

Similar reference characters denote corresponding features consistently throughout the attached drawings.

### DETAILED DESCRIPTION OF THE PREFERRED EMBODIMENTS

The present invention is an information relaying method, apparatus, and/or computer program product for relaying personal, business, confidential, rejection/denial, number transfer, and/or business stationary contact information between individuals. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

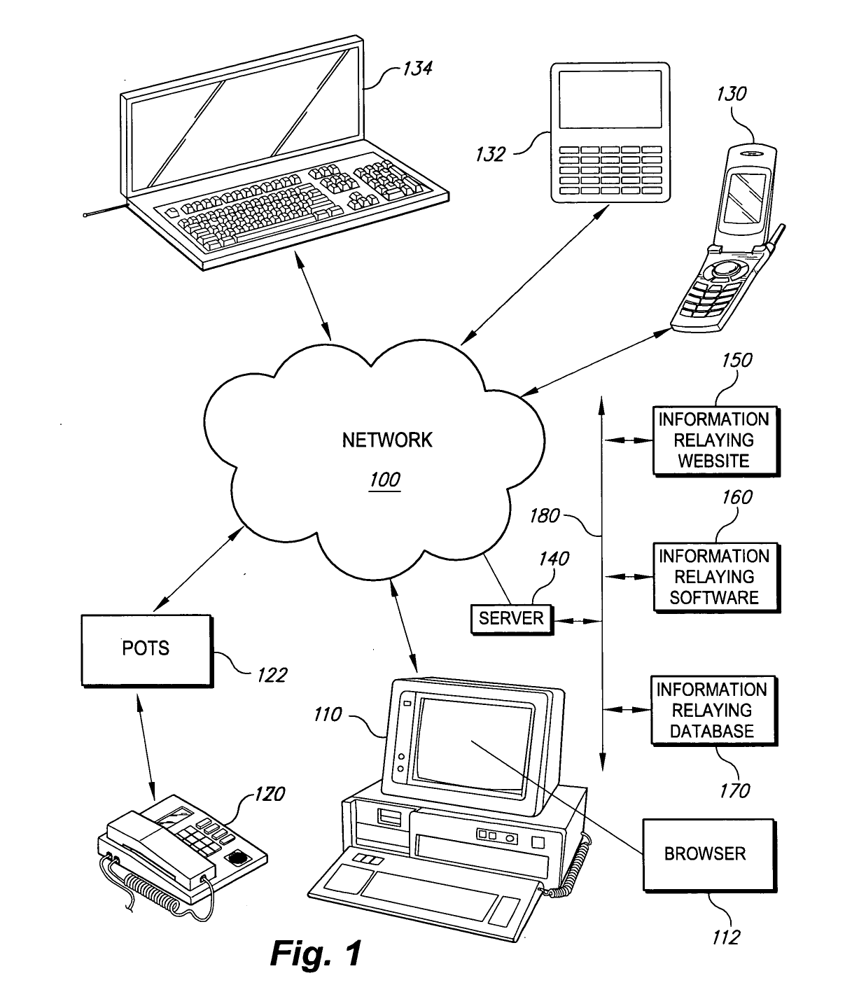

The to the drawings, FIG. 1 shows an arrangement 100 for carrying out an information relaying method according to the present invention. A computer arrangement 110 may interconnect via a browser 112 with an information relaying website 150 over a network 100. A variety of other information relaying apparatuses 120, 130, 132, and 134 may also interconnect with the information relaying website 150 and with each other over the network 100 wirelessly and/or non-wirelessly. The information relaying website 150 is administered by a server 140, information relaying software 160, and an information relaying database 170. The information relaying website 150, information relaying software 160, and the information relaying database 170 are interconnected via a communication bus 180.

The information relaying apparatuses are illustrated as communication devices including a standard landline telephone 120, a cellular phone (cell phone) 130, a personal digital assistant (PDA) 132, and a smart phone 134. However, information relaying apparatuses can be provided in any other desired configuration, including personal accouterments, such as a watch, a ring, a bracelet, a necklace, an earring, a pendant, an eyeglass frame, an earplug, etc., clothing items, such as a cap, a hat, a scarf, a jacket, pants, a tie, a dress, shoes, sandals, etc., utility items, such as a key fob, a pen, a pocket knife, a calculator, an identification card, etc., computer devices, such as a BlackBerry, an embedded device, a smart phone, etc., or any other suitable or desired configuration.

The computer arrangement 110 can interconnect with the information relaying apparatuses 120, 130, 132, and 134. The computer arrangement 110 may include any type of computer device including a processor, such as a desktop computer, a laptop computer, a network computer, a mainframe computer, etc. The computer arrangement 162 can communicatively interact with the information relaying apparatuses 120, 130, 132, and 134 with any type of browser 112.

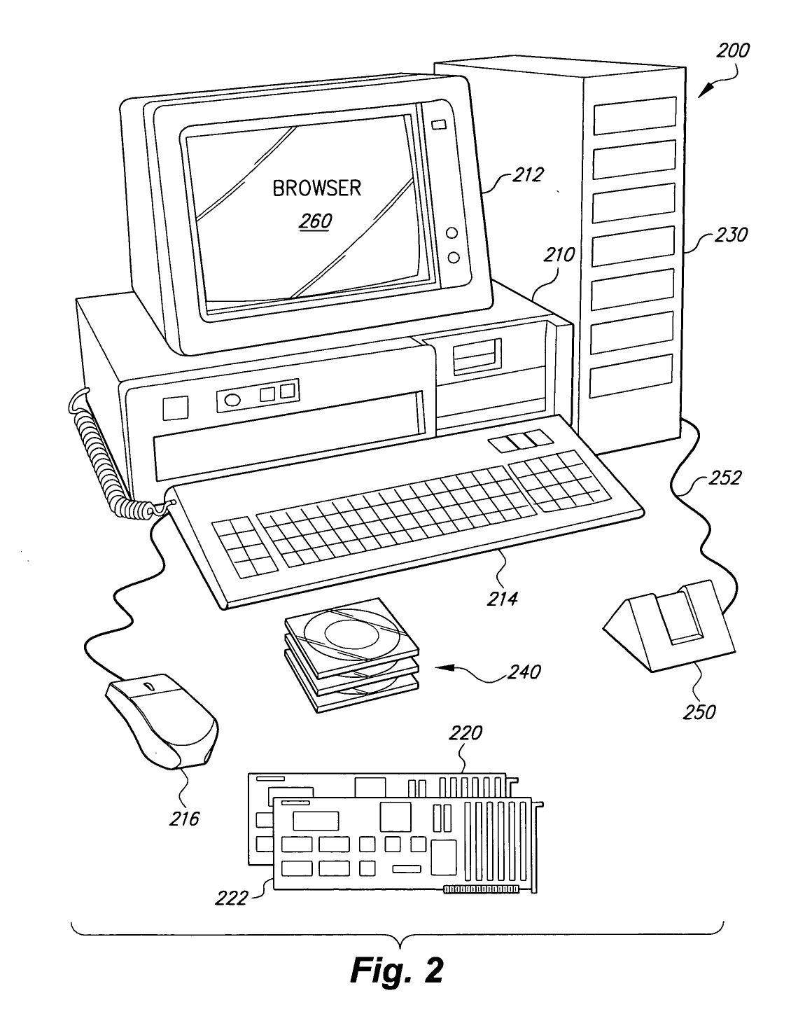

FIG. 2 shows details of a computer arrangement 200 configured for use with information relaying apparatuses according to the present invention. The computer arrangement 200 includes a computer device 210, a monitor 212, a keyboard 214, a mouse 216, and a port/holder 250 configured for being interconnected between the computer device 210 via a cable or other linking arrangement with an information relaying apparatus. The computer device 210 is interconnected with a memory storage unit 230 via a cable or other linking device, and can be configured to be used with memory in the form of computer usable mediums, such as memory boards 220, 222, with removable memory elements 240 (e.g., CD-ROMS, floppy disks, etc.), or the like. The computer arrangement 200 may be configured in the form of any type of computer as desired, such as a desktop computer, a laptop computer, a palmtop computer, a network computer, a PDA, a BlackBerry, a cell phone, an embedded device, a smart phone, or any other suitable computer device.

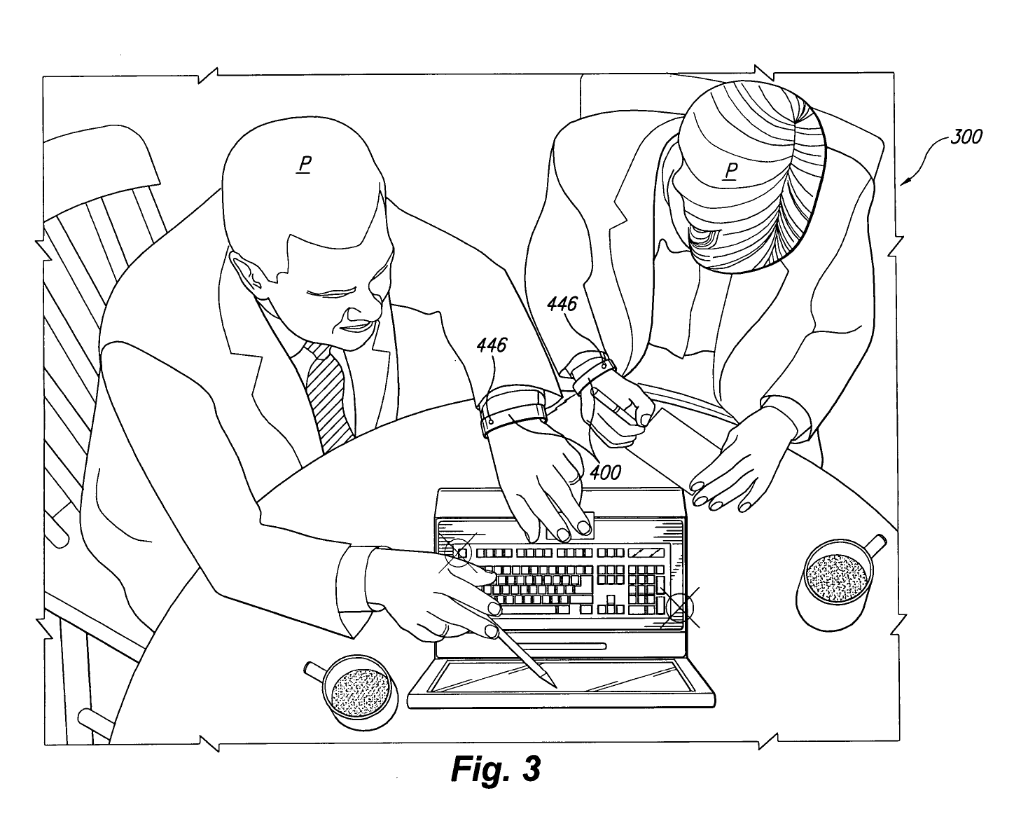

Two individuals P engaged in a business meeting 300 are shown in FIG. 3. Each individual P is wearing an information relaying apparatus 400 with information relaying circuitry mounted therein. In this instance, the information relaying apparatus 400 is configured as a wristband made of durable, water resistant or waterproof material, with information relaying circuitry mounted therein, and preferably a minimal number of interface keys or buttons 446. The material of the information relaying apparatus 400 may be clear, transparent, and/or translucent, or may be opaque and be provided with any type of color or combination of colors, or have decorative symbols or indicia provided thereon. The outward appearance of the information relaying apparatus 400 may also be varied to blend in with different environments (e.g. social versus business, younger crowd versus older crowd, etc.).

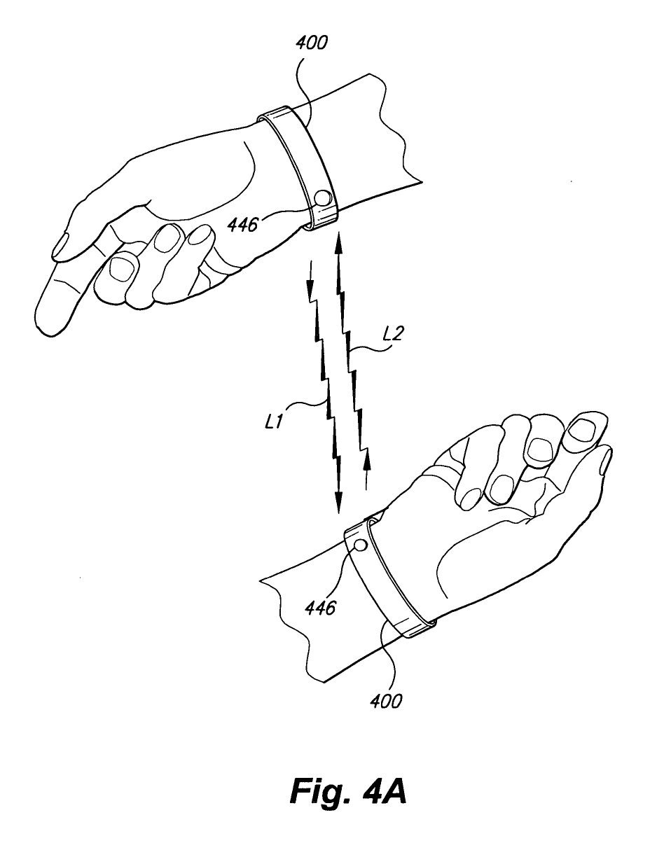

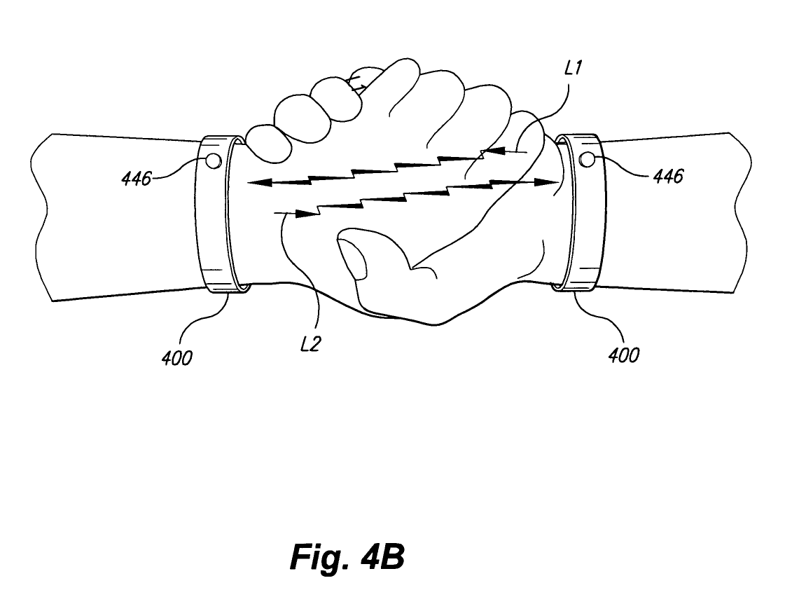

As shown in FIGS. 4A and 4B, the information relaying apparatuses 400 are configured to wirelessly transfer personal, business, confidential, rejection/denial, number transfer, and/or business stationary contact information, from one information relaying apparatus 400 to another 400 via wireless communication links L1 and L2, and are also configured to be set in an off mode to prevent or limit the transfer of contact information from one information relaying apparatus 400 to another 400. The information relaying apparatus 400 can also non-wirelessly transfer contact information to or be programmed via the remote computer arrangement 200 shown in FIG. 2 via interconnecting the information relaying apparatus 400 with the port/holder 250 of the computer arrangement 200.

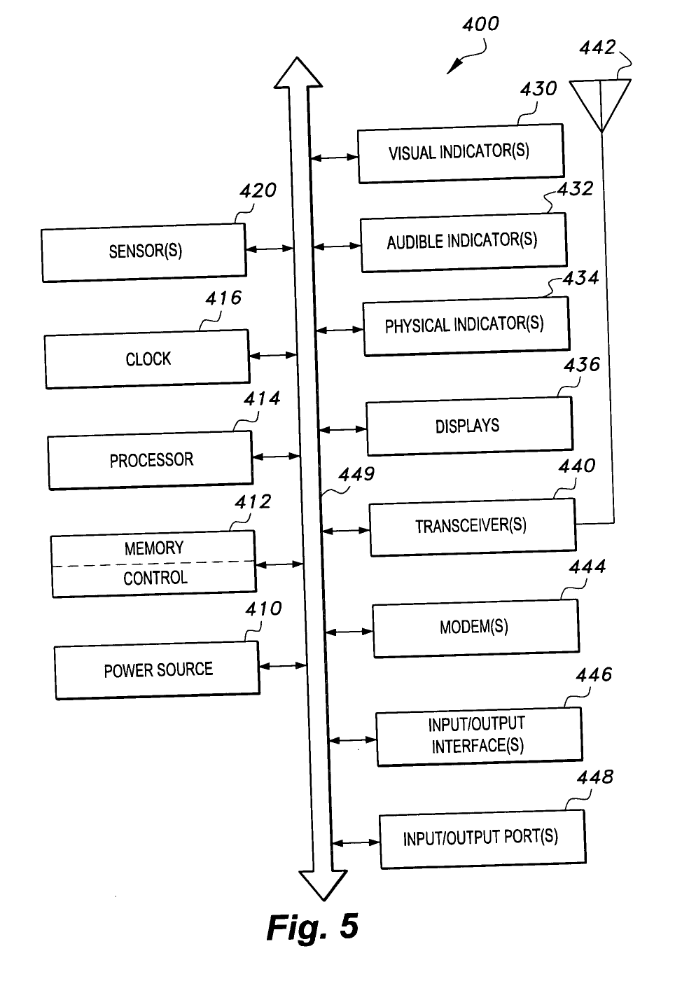

Referring to FIG. 5, components of information relaying circuitry of an information relaying apparatus 400 can include a power source 410, memory 412 with control software in the form of information relaying software modules embodied therein, a processor 414, a clock 416, one or more sensors 420, one or more visual indicators 430, one or more audible indicators 432, one or more physical indicators 434, one or more displays 436, one or more transceivers 440, an antenna 442, one or more modems 430, one or more input/output interfaces 446, one or more input/output ports 448, and a communication bus 449 electrically interconnecting the components. The information relaying apparatus 400 may include a locking mechanism configured to enable locking and unlocking of the information relaying apparatus 400 to prevent accidental activation of the information relaying apparatus 400 through inadvertent or intentional engagement of one of the input/output interfaces 446. The information relaying apparatus 400 may also be configured with inductive coupling capacity to enable the information relaying apparatus 400 to transfer large amounts of data to another information relaying apparatus 400 through use mere touching of one information relaying apparatus 400 to another through wire coils embedded in each information relaying apparatus 400.

The power source 410 is preferably one or more self contained batteries, and may be one or more rechargeable or non-rechargeable silver oxide batteries, lithium batteries, nickel-cadmium batteries, alkaline batteries, or the like. However, the power source 410 may also be or include one or more solar cells, a kinetic converter to convert the kinetic energy of the user to electrical power, or the like.

The information relaying apparatus 400 is configured to utilize one or more computer usable memories 412 operably configured for use with one or more processors 414. The memory 412 is configured as a computer usable medium. The processor 414 can be configured as a micro-controller, control logic, firmware, or other circuitry. As used herein, a “computer usable medium” includes a non-volatile medium, a volatile medium, and/or an installation medium. A non-volatile medium may be a magnetic medium, hard disk, a solid state disk, optical storage, Flash memory, read only memory (ROM), electrically eraseable programmable read only memory (EEPROM), parameter random access memory (PRAM), etc. The processor and memory can be mounted on a circuit board and can be configured as a microcontroller integrated circuit (IC), a Flash random access memory (RAM) IC, an Infrared Data Association (IrDA) Codec IC, etc. Various known electrical components can be mounted on such a circuit board, including a crystal oscillator, a voltage regulator IC, capacitor(s), resistor(s), diode(s), momentary contact switch(es), LED(s), USB(s), power connector(s), etc.

A volatile medium may be RAM, dynamic RAM (DRAM), Direct Rambus DRAM (DRDRAM), double-data rate DRAM (DDR DRAM), double-data rate synchronous DRAM (DDR SDRAM), enhanced DRAM (EDRAM), enhanced synchronous DRAM (ESDRAM), extended data out (EDO) DRAM, burst EDO (BEDO) DRAM, fast page mode DRAM (FPM DRAM), Rambus DRAM (RDRAM), SyncLink DRAM (SLDRAM), synchronous RAM (SRAM), synchronous DRAM (SDRAM), synchronous graphic RAM (SGRAM), video RAM (VRAM), window RAM (WRAM), etc. An installation medium may be a CD-ROM, a DVD, a DVD-R, a DVD+R, a DVD-RW (writable), a DVD+RW (writable), a floppy disk, a removable disk, etc., on which computer programs are stored for loading into a computer device.

The memory 412 of the information relaying apparatus 400 includes control software in the form of a number of computer usable information relaying software modules stored therein. The information relaying software modules each include a plurality of computer instructions that may be carried on any computer usable medium according to the desires of the user. The information relaying software modules include software modules for configuring the information relaying apparatus 400 in a number of modes including a personal contact mode, a business contact mode, a confidential contact mode, a rejection/denial contact mode, a number transfer contact mode, a business stationary contact mode, and/or an off mode. Software modules for configuring the information relaying apparatus 400 in additional modes may be provided as desired.

The information relaying software modules are configured to receive, store, delete, and/or transfer contact information parameters such as text, audio, video, combinations thereof, or other multimedia type data. Such contact information parameters include, but are not limited to, full names, business phone numbers, business fax numbers, business cell numbers, business email addresses, business mailing addresses, business post office addresses, home phone numbers, home fax numbers, personal cell numbers, personal email addresses, home mailing addresses, home post office addresses, etc. The contact information parameters can also include or be a photograph of the particular contact individual, a voice message or vmail, a video stream, Telephony Control/signaling for phones (TCS-binary), TCS-AT, Personal Area Networking (PAN), audiovisual (A/V), Object Exchange (OBEX) protocol, still imagery, etc. As described below, the contact information parameters can be grouped in various contact mode subcategories. Such subcategories can include, but are not limited to, data, pictures, files, brochures, agendas, passports, medical information, etc.

Additional computer usable information relaying software modules can be stored separately on an installation medium to enable a user to program the information relaying apparatus 400 from a computer device by interconnecting the information relaying apparatus 400 with the computer device via the input/output ports 448.

Such additional information relaying software modules can enable a user to enter a variety of information including personal, business, confidential, rejection/denial, number transfer, and/or business stationary contact information via some type of browser or graphical user interface (GUI) 260 (see FIG. 2) configured for receiving the personal, business, confidential, rejection/denial, number transfer, and/or business stationary contact information. The browser 260 provided by the information relaying software modules can guide the user during the contact information input process using the computer arrangement 200. Once the contact information has been entered and appropriate settings are provided to the information relaying software modules, the information relaying apparatus 400 is then operationally configured.

Other settings that the user may store in the information relaying software modules include such parameters as proximate distance, or movement or vibration intensity of one information relaying apparatus 400 relative to another to cause the one apparatus 400 to relay contact information with another information relating apparatus, e.g., another cell phone, and the date or time if so desired. The browser 260 may provide security measures, such as entry of a personal identification number, a password, a user name, etc., before any settings can be changed.

The information relaying software modules can be configured to guide the user and help the user to do the following in a user friendly way: (1) enable the user to program his/her personal, business, confidential, rejection/denial, number transfer, and/or business stationary contact information and then download this information into the information relaying apparatus 400; (2) enable the user to change their personal, business, confidential, rejection/denial, number transfer, and/or business stationary contact information at any time; (3) provide the user a heads-up response if duplicate personal, business, confidential, rejection/denial, number transfer, and/or business stationary contact information has been retrieved from the information relaying apparatus 400, such as saving a file that is the same as one that has already been saved; (4) enable the user to upload new personal, business, confidential, rejection/denial, number transfer, and/or business stationary contact information once retrieved; (5) indicate to the user how many contacts have been retrieved; (6) enable the user to modify or delete data once collected, etc.; and (7) provide the user with point-to-point transfer of information between the information relaying apparatus 400 and a remote object configured with information relaying circuitry appropriately configured to transfer particular contact information associated with the object. For example, a user may have an information relaying apparatus 400 and be passing a real estate sign configured with information relaying circuitry that relays information data about the particular real estate property to the user automatically or due to appropriate settings on the information relaying apparatus of the user.

The user friendly port/holder 250 is provided to interconnect with the input/output port(s) 448 of the information relaying apparatus 400, and can be provided with a universal cable connection 252, such as a universal serial bus (USB) cable or the like, to enable the information relaying apparatus 400 to be interconnected with a remote computer device via the port/holder. The information relaying apparatus 400 and/or information relaying software modules are preferably Microsoft Windows and/or Microsoft Office compatible, but may be compatible with any type of operating system.

The clock 416 serves as a timing mechanism to provide timing data corresponding to particular occurrences associated with the sensor(s) 420. The clock 416 can also be used to provide, track, and/or recall the time and date predetermined or preset by the user. Any predetermined or preset time or date can be used as a default setting to default the clock 416 back after providing timing data for a particular contact information transfer or receipt recordation occurrence. The sensor(s) 420 are preferably proximity sensor(s) to detect whether the information relaying apparatus 400 is positioned proximate another information relaying apparatus 400 (without touching) or a device equipped with information relaying circuitry according to the invention. However, the sensor(s) 420 may also be vibration or movement sensor(s) to sense movement near the information relaying apparatus 400.

When one information relaying apparatus 400 is moved to a position proximate or within a predetermined distance from another information relaying apparatus 400, or senses movement near the information relaying apparatus 400, the associated sensor(s) 420 provide a signal of the proximate positioning, or movement or vibration of the apparatus 400, whereupon the processor 414 obtains timing data from the clock 416 and stores the timing data in the memory 412.

The apparatus 400 can be configured with one or more visual indicators 430 that can be configured to provide visual indications for a variety of occurrences. Such visual indicators 430 emit light to provide the visual indication and are preferably light emitting diodes (LEDs) of any desired color, but may be any type of light. For example, red LEDs may illuminate to indicate to users when placement between two apparatuses 100 is within a predetermined proximate range, or when movement or vibration is sensed near the information relaying apparatus 400. Such placement may automatically activate the associated visual indicators 430, if so provided.

One or more optional audible indicator(s) 434 can be provided to emit a distinctive audible sound when placement between two apparatuses 400 is within a predetermined proximate range or when movement or vibration of one apparatus 400 is detected by another apparatus 400, and can be a speaker that is powered by an amplifier to emit a buzzer, chirp, chime, or the like. Alternatively, the audible indicator 428 may be a speaker that relays an audible communication information, such as a recorded message, a relayed communication message, a relayed live transmission, or the like. One or more optional physical indicator(s) 434 can be provided to produce a physical movement of the information relaying apparatus 400, such as a vibration or the like, when placement between two apparatuses 400 is within a predetermined proximate range or when movement or vibration of one apparatus 400 is detected by another apparatus 400.

One or more displays 436, such as a liquid crystal display (LCD), an LED display, a plasma display, or the like, can be provided to enable the user to view information relaying settings or other data stored on the information relaying apparatus 400. The display(s) 436 can also be configured to provide a limited screen read-out capability. For example, consider the apparatus 400 as a cell phone. When the cell phone user is walking through a crowded area, such as a bar or restaurant, the user may not want others to which they are relaying contact information to read their relayed contact information while to they are in the other person's presence.

The limited screen read-out capability enables such a user to cause the receiving party's information relaying apparatus 400 to read limited information at the time of transfer, such as the time and date of the transfer, or the like. The limited screen read-out capability can enable a user to limit the displayed contact information to be just a telephone or cell number where it can be read at the moment of transfer. For example, suppose a girl is across the bar and a user of an apparatus 400 is making eyes at her so they send her their number. However, this phone number and perhaps a time and date of transfer read-out could be designated as being the only types of data that could be able to be read right then and there. All other data transfer could be designated as only being able to be read once the user returns back to his/her computer.

One or more transceivers 440 are provided to enable wireless transfer of personal, business, confidential, rejection/denial, number transfer, and/or business stationary contact information between the information relaying apparatus 400 and another information relaying apparatus 400 or a remote computer device. The transceiver(s) 440 can transfer data in both directions so that updated information relaying instructions or commands can be set by the user.

One or more input/output interface(s) 446, such as keys, buttons, switches, or the like, can be provided to enable the user to set information relaying settings or other data in the information relaying apparatus 400 using the keys, buttons, switches, or the display(s) 436 of the information relaying apparatus 400. An input/output interface 446 can be provided with a name such as “sync” or the like, and be configured as key, button, etc., to enable users who are carrying or wearing an information relaying apparatus 400, and are proximate one another, to cause contact information to be relayed between the two apparatuses 400 upon depression, engagement, or activation of each associated input/output interface 446. Such an interface 446 can be provided to limit contact information transfer until desired through proactive action on the part of each associated user.

The input/output interface(s) 446 enable the user to shift the operational mode setting of the information relaying apparatus 400 from one or more of various different mode settings (e.g., a personal contact mode setting, a business contact mode setting, a confidential contact mode, and an off mode setting, etc.). The input/output interface(s) 446 may also be configured to operate with biometric information as input parameters, such as a finger print, voice, signature, DNA, facial structure, iris, retina, etc. The input/output interface(s) 446 enable the user to be in complete control of what setting the information relaying apparatus 400 is on in a given environment. While the information relaying apparatus 400 can be confidential in nature, the user is able to know themselves the settings to which they have set the apparatus 400.

The input/output port(s) 448 can transfer data in both directions so that updated information relaying instructions or commands can be set by the user. The transceiver(s) 440 and/or the input/output port(s) 448 are preferably configured to use infrared communication technology. However, the transceiver(s) 440 and/or the input/output port(s) 448 may use other communication technologies such as cables, fiber optics, radio frequency, or the like. A plurality of input/output port(s) 448 may be provided to support multiple communication protocols or methods, or may include a universal port capable of transmitting data in several different modes. Stored data can be downloaded to, or new information relaying program instructions and data can be uploaded from a computer, a communication station, or the like.

The information relaying apparatus 400 is configured to logically interconnect wirelessly to other apparatuses 400 containing information relaying circuitry via the transceiver and antenna 442, or non-wirelessly to a remote computer device via the input/output port(s) 448. Wireless interconnection may occur via any known technique (e.g., wireless local area network (WLAN) protocol, IrDA communication standard, BlueTooth protocol, HomeRF protocol, IEEE 802.11 (FireWire) protocol, Global System for Mobile Communications (GSM) protocol, ReFLEX protocol, etc.). Non-wireless interconnection may occur through a network system via any number of switches, such as a LAN, a wide area network (WAN), an intranet, an extranet, the internet, etc. Any type of a remote computer device may be interconnected with the information relaying apparatus 400, such as a desktop computer, a laptop computer, a palmtop computer, a network computer, a PDA, a BlackBerry, a cell phone, an embedded device, a smart phone, or any other suitable computer device.

When placed in a LAN networking environment, the information relaying apparatus 400 connects to the local network through the input/output port(s) 448. When used in a WAN networking environment such as the internet, the information relaying apparatus 400 establishes communications over the network using the modem(s) 444. The modem 444 may be internal or external to the information relaying apparatus 400.

As described above with FIGS. 2, 3A and 3B, the information relaying apparatuses 400 are configured to wirelessly transfer personal, business, confidential, rejection/denial, number transfer, and/or business stationary contact information from one information relaying apparatus 400 to another 400 via the transceivers 440 and the antenna 442 via wireless communication links L1 and L2, and are also configured to be set in an off mode to prevent or limit the transfer of contact information from one information relaying apparatus 400 to another 400. The information relaying apparatuses 400 can also non-wirelessly transfer contact information to or be programmed via the computer arrangement 200 via interconnecting the input/output port(s) 448 of the information relaying apparatus 400 with the computer arrangement 200.

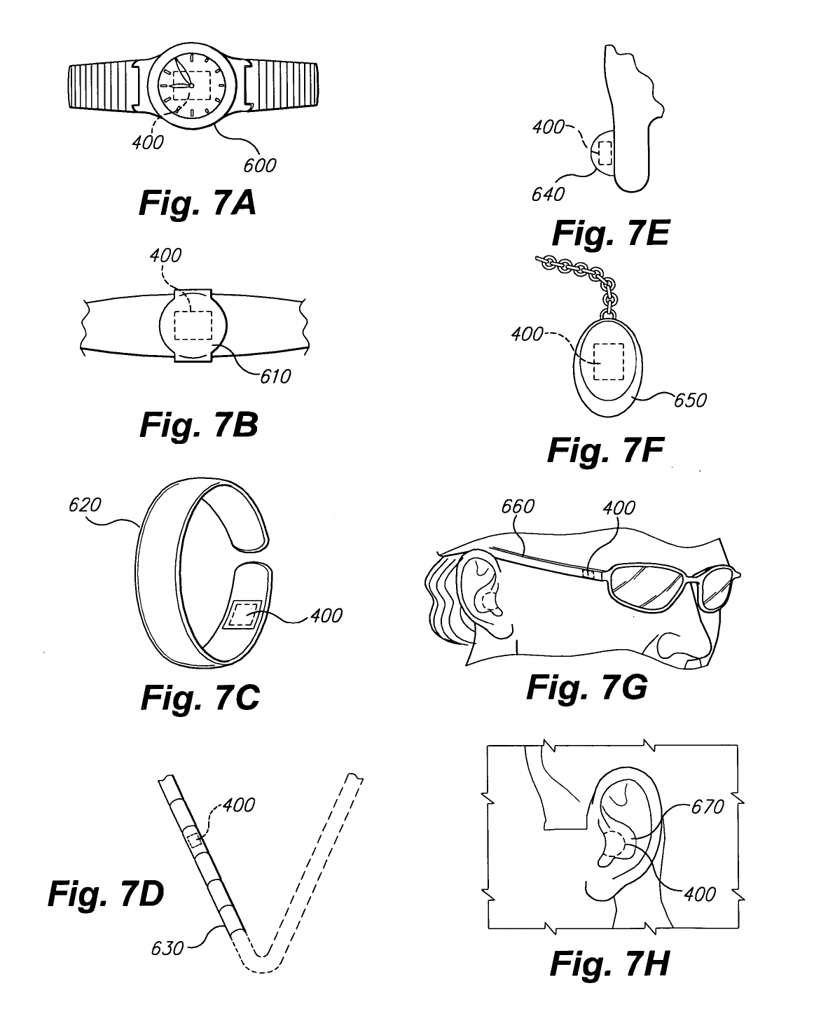

As shown in FIGS. 7A-7H, the information relaying apparatus 400 may be configured in any number of ways that incorporate the information relaying apparatus 400 in the form of information relaying circuitry according to the invention. Such information relaying apparatus examples shown in FIGS. 7A-7H include, but are not limited to, personal accouterments including a watch 600, a ring 610, a bracelet 620, a necklace 630, an earring 640, a pendant 650, an eyeglass frame 660, and an earplug 670, or any other type of personal accouterments. As described above, the information relaying apparatus 400 may also be configured in any other desired configuration, including clothing items, such as a hat, a scarf, a jacket, pants, a tie, a dress, shoes, sandals, etc., utility items, such as a key fob, a pen, a pocket knife, a calculator, an identification card, etc., computer devices, such as a BlackBerry, an embedded device, a smart phone, etc., or any other suitable or desired configuration.

As previously described, the information relaying apparatus 400 is configured for being operated in a number of operational mode settings including a personal contact mode setting, a business contact mode setting, a confidential contact mode, and an off mode setting. Other operational modes can include rejection/denial mode, a number transfer mode, and a business stationary mode. The information relaying apparatus 400 can be configured for being operated in additional modes as desired. The contact information parameters described above can be grouped in various contact mode subcategories. Such subcategories can include, but are not limited to data, pictures, files, brochures, agendas, passports, medical information, etc.

The information relaying apparatus 400 can also be configured to recognize a mode that is being transferred when a transfer is made from apparatus 400 to apparatus 400. Each apparatus 400 can recognize the designated contact mode that is being transferred and can process the data in that particular contact mode. Once the user returns back to their computer arrangement 200 to retrieve the data, their apparatus 400 can tell them via the browser or GUI 260 and associated information relaying software modules what mode has been received, time, date, etc.

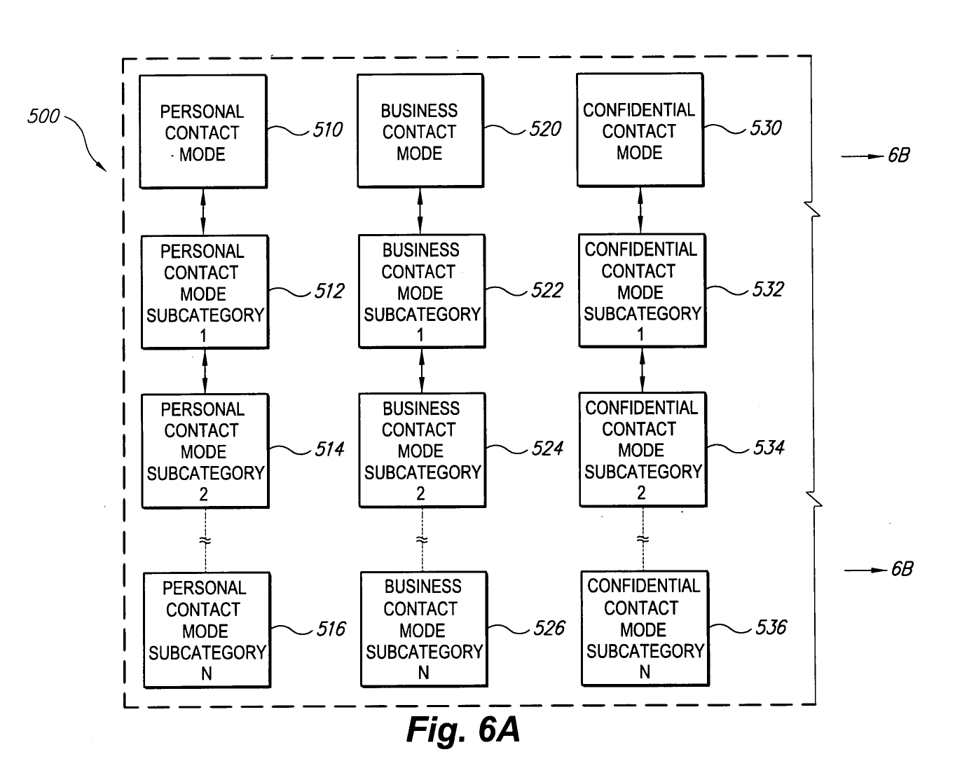

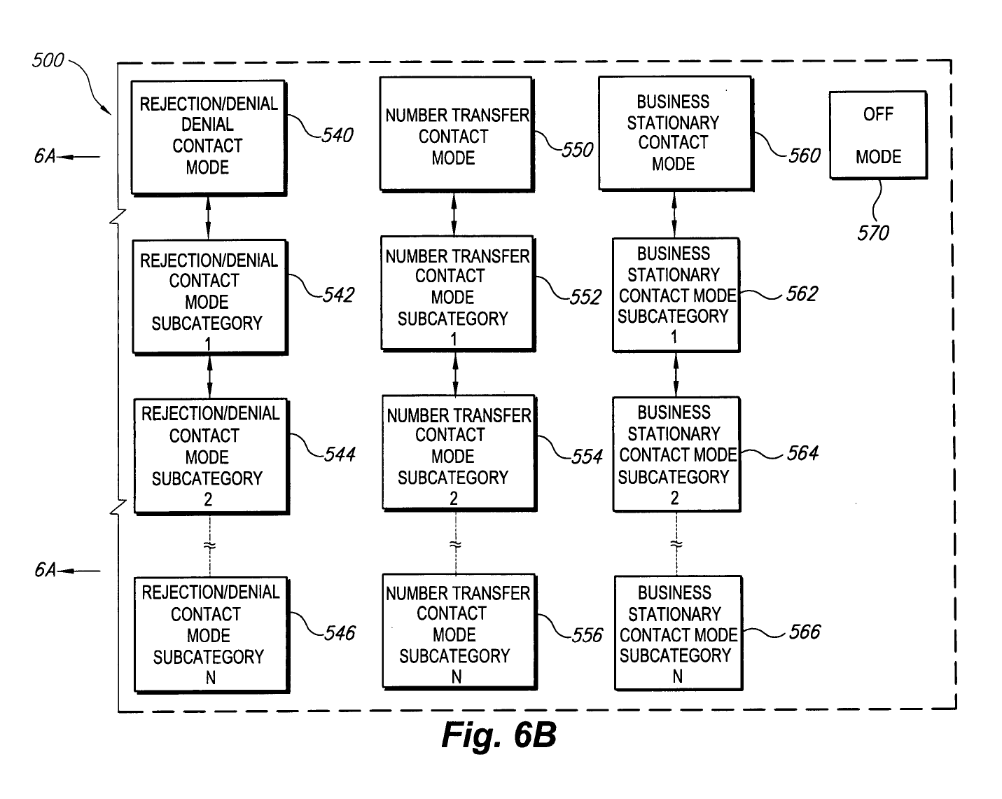

FIGS. 6A and 6B show a diagram 500 of an example of a hierarchical mode setting configuration. As illustrated, the personal contact mode 510 can have personal contact mode subcategory 1 512, personal contact mode subcategory 2 514, . . . , and personal contact mode subcategory N 516. The business contact mode 520 can have business contact mode subcategory 1 522, business contact mode subcategory 2 524, . . . , and business contact mode subcategory N 526. The confidential contact mode 530 can have confidential contact mode subcategory 1 532, confidential contact mode subcategory 2 534, . . . , and confidential contact mode subcategory N 536. The rejection/denial contact mode 540 can have rejection/denial contact mode subcategory 1 542, rejection/denial contact mode subcategory 2 544, . . . , and rejection/denial contact mode subcategory N 546. The number transfer contact mode 550 can have number transfer contact mode subcategory 1 552, number transfer contact mode subcategory 2 554, . . . , and number transfer contact mode subcategory N 556. The business stationary contact mode 560 can have business stationary contact mode subcategory 1 562, business stationary contact mode subcategory 2 564, . . . , and business stationary contact mode subcategory N 566. The off mode 540 could have various subcategory modes as well, as desired. The subcategories enables a user of an information relaying apparatus 400 to selectively choose a particular subcategory of contact information parameters to relay to recipient information relaying apparatus users. Such selective choosing can be made through interconnection of the information relaying apparatus 400 with a computer arrangement 200, or during the time of information relaying activities through use of associated input/output interfaces 446 (e.g., buttons, keys, etc.).

The personal contact mode 510 and any designated personal contact mode subcategories 512, 514, 516, provide the ability of a user to share designated contact information with another individual during a social encounter. The designated contact information may include basic personal contact information, personal pictures, personal attached files, etc. For example, suppose a person is in a restaurant/bar environment and they meet another person with whom they want to share contact information with. They may only want to give that person particular designated personal contact information, e.g., their home phone number, home fax number, personal email address, personal cell number, etc. The user can set the information relaying apparatus 400 in the personal contact mode via depressing or otherwise engaging the input/output interface buttons or keys 446 which may be positioned in an unrevealing area of the information relaying apparatus 400 so as to be unseen by other information relaying apparatus users.

The interface buttons or keys 446 may be depressed or otherwise engaged a predetermined number of times to obtain a desired personal contact mode subcategory 512, 514, 516. Such hidden discretion enhances any undesired awkwardness. As described above, information relaying apparatuses 400 of the users can also be provided with a “sync” button or key to enable the users to proactively determine whether and what contact information they want to transfer. The users can depress or otherwise engage a “sync” button or key to provide the user with full control over determining whether to have simplified data exchange or to have a complex data exchange.

During such activity, a visual indicator 430 on an associated apparatus 400 could emit a common color at the moment of contact information exchange to inform either party involved that their apparatus 400 is transferring and/or receiving contact information. The apparatuses 400 can be configured to automatically recognize and/or store any data that is transferred and/or received in the appropriate personal contact mode subcategory. The settings of the personal contact mode can be altered by the user during programming via interconnecting the information relaying apparatus with a remote computer arrangement 200.

The business contact mode 520 and business contact mode subcategories 522, 524, 526, provide the user with the ability of a user to share business contact information without sharing personal contact information. The business contact information can include basic business contact information, business pictures, business attached files, business literature, etc. Such business contact information may include full names, business phone numbers, business fax numbers, business cell numbers, business email addresses, business mailing addresses, business post office addresses, etc.

The interface buttons or keys 446 may be depressed or otherwise engaged a predetermined number of times to obtain a desired business contact mode subcategory 522, 524, 526. Such hidden discretion enhances any undesired awkwardness. As described above, information relaying apparatuses 400 of the users can also be provided with a “sync” button or key to enable the users to proactively determine whether and what contact information they want to transfer. The users can depress or otherwise engage a “sync” button or key to provide the user with full control over determining whether to have simplified data exchange or to have a complex data exchange.

During such activity, a visual indicator 430 on an associated apparatus 400 could emit a common color at the moment of contact information exchange to inform either party involved that their apparatus 400 is transferring and/or receiving contact information. The apparatuses 400 can be configured to automatically recognize and/or store any data that is transferred and/or received in the appropriate business contact mode subcategory. The settings of the business contact mode can be altered by the user during programming via interconnecting the information relaying apparatus with a remote computer arrangement 200.

The confidential contact mode 530 and confidential contact mode subcategories 532, 534, 536 provide the ability of a user to selectively share contact information with another individual during any occasion (e.g., business or personal). The contact information can include basic contact information, pictures, attached files, etc. The settings for the confidential contact mode may include only one or more contact parameters, such as their name, their personal, business, and/or confidential email address, etc. The user can set the information relaying apparatus 400 in the confidential contact mode via depressing or otherwise engaging the input/output interface buttons or keys 446 which may be positioned in an unrevealing area of the information relaying apparatus 400 so as to be unseen by other information relaying apparatus users. Such hidden discretion enhances any undesired awkwardness.

The interface buttons or keys 446 may be depressed or otherwise engaged a predetermined number of times to obtain a desired confidential contact mode subcategory 532, 534, 536. As described above, information relaying apparatuses 400 of the users can also be provided with a “sync” button or key to enable the users to proactively determine whether and what contact information they want to transfer. The users can depress or otherwise engage a “sync” button or key to provide the user with full control over determining whether to have simplified data exchange or to have a complex data exchange.

During such activity, a visual indicator 430 on an associated apparatus 400 could emit a common color at the moment of contact information exchange to inform either party involved that their apparatus 400 is transferring and/or receiving contact information. The apparatuses 400 can be configured to automatically recognize and/or store any data that is transferred and/or received in the appropriate personal contact mode subcategory. The settings of the confidential contact mode 530 and confidential contact mode subcategories 532, 534, 536 can be altered by the user during programming via interconnecting the information relaying apparatus with a remote computer arrangement 200.

The rejection/denial contact mode 540 and business contact mode subcategories 542, 544, 546, provide the user with the ability of a user to provide rejection and/or denial messages to other users. The rejection/denial contact information can include basic rejection messages such as “Sorry, I have a boyfriend already”, “You're sweet anyway!”, or a more abrasive message such as “Get Lost”.

The interface buttons or keys 446 may be depressed or otherwise engaged a predetermined number of times to obtain a desired rejection/denial contact mode subcategory 542, 544, 546. Such hidden discretion enhances any undesired awkwardness. As described above, information relaying apparatuses 400 of the users can also be provided with a “sync” button or key to enable the users to proactively determine whether and what contact information they want to transfer. The users can depress or otherwise engage a “sync” button or key to provide the user with full control over determining whether to have simplified data exchange or to have a complex data exchange.

During such activity, a visual indicator 430 on an associated apparatus 400 could emit a common color at the moment of contact information exchange to inform either party involved that their apparatus 400 is transferring and/or receiving contact information. The apparatuses 400 can be configured to automatically recognize and/or store any data that is transferred and/or received in the appropriate business contact mode subcategory. The settings of the rejection/denial contact mode can be altered by the user during programming via interconnecting the information relaying apparatus with a remote computer arrangement 200.

The number transfer contact mode 550 and number transfer contact mode subcategories 552, 554, 556, provide the user with the ability of a user to share number transfer contact information without sharing personal contact information. The number transfer contact information can include basic personal phone numbers, personal cell numbers, personal fax numbers, business phone numbers, business fax numbers, business cell numbers, etc.

The interface buttons or keys 446 may be depressed or otherwise engaged a predetermined number of times to obtain a desired number transfer contact mode subcategory 552, 554, 556. Such hidden discretion enhances any undesired awkwardness. As described above, information relaying apparatuses 400 of the users can also be provided with a “sync” button or key to enable the users to proactively determine whether and what contact information they want to transfer. The users can depress or otherwise engage a “sync” button or key to provide the user with full control over determining whether to have simplified data exchange or to have a complex data exchange.

During such activity, a visual indicator 430 on an associated apparatus 400 could emit a common color at the moment of contact information exchange to inform either party involved that their apparatus 400 is transferring and/or receiving contact information. The apparatuses 400 can be configured to automatically recognize and/or store any data that is transferred and/or received in the appropriate number transfer contact mode subcategory. The settings of the number transfer contact mode can be altered by the user during programming via interconnecting the information relaying apparatus with a remote computer arrangement 200.

The business stationary contact mode 560 and business stationary contact mode subcategories 562, 564, 566, provide the user with the ability of a user to share business contact information associated with a stationary object, such as real estate property for sale indicated on a sign. The business stationary contact information can include information regarding the stationary object, pictures of the stationary object, etc. Such business stationary contact information may include other information, such as realtor/contact names, realtor/contact phone numbers, fax numbers, cell numbers, email addresses, mailing addresses, etc.

The interface buttons or keys 446 may be depressed or otherwise engaged a predetermined number of times to obtain a desired business stationary contact mode subcategory 562, 564, 566. Such hidden discretion enhances any undesired awkwardness. As described above, information relaying apparatuses 400 of the users can also be provided with a “sync” button or key to enable the users to proactively determine whether and what contact information they want to transfer. The users can depress or otherwise engage a “sync” button or key to provide the user with full control over determining whether to have simplified data exchange or to have a complex data exchange.

During such activity, a visual indicator 430 on an associated apparatus 400 could emit a common color at the moment of contact information exchange to inform either party involved that their apparatus 400 is transferring and/or receiving contact information. The apparatuses 400 can be configured to automatically recognize and/or store any data that is transferred and/or received in the appropriate business stationary contact mode subcategory. The settings of the business stationary contact mode can be altered by the user during programming via interconnecting the information relaying apparatus with a remote computer arrangement 200.

The off mode 540 and any designated off mode subcategories (not shown) do not activate or deactivate the information relaying apparatus 400. Rather, the off mode enables a user to restrict the transfer of personal, business, confidential, rejection/denial, number transfer, and/or business stationary contact information to other users wearing an information relaying apparatus 400. One of the input/output interface 448 buttons or keys can be configured to activate or deactivate the information relaying apparatus 400, e.g., to turn the information relaying apparatus 400 on or off.

Non-activation of the off mode enables a user to operate the information relaying apparatus 400 and transfer personal, business, confidential, rejection/denial, number transfer, and/or business stationary contact information to another information relaying apparatus 400 in a position proximate to the relaying apparatus 400, or when movement or vibration of one apparatus 400 is detected by another apparatus 400, depending upon whether the information relaying apparatus is set in the personal contact mode, the business, and/or confidential contact mode. However, as described for the other modes, the information relaying apparatus 400 can also be configured with a “sync” button or key to enable the users to proactively determine whether and what contact information they want to transfer. The users can depress or otherwise engage a “sync” button or key to provide the user with full control over determining whether to have simplified data exchange or to have a complex data exchange.

Activation of the off mode causes the information relaying apparatus 400 to not provide transfer of personal, business, confidential, rejection/denial, number transfer, and/or business stationary contact information, regardless of any other settings. This enables an individual that is not interested in sharing personal, business, confidential, rejection/denial, number transfer, and/or business stationary mode contact information to activate the off mode, and provides a polite, comfortable, and silent way of saying “No” to others. Individuals equipped with information relaying apparatuses 400 who want to receive an information transfer from the individual who activates the off mode of their information apparatus 400 would not receive any contact information from the individual. When the individuals who wanted to receive contact information check their information relaying apparatuses 400 via the display(s) 436, if so equipped, or via a remote computer arrangement 200 interconnected to the information relaying apparatus 400 via the input/output port(s) 448, they then learn that no contact information was transferred.

Examples of how such a capability becomes useful include a situation where a girl blows off a guy at a restaurant/bar, a situation where a customer who does care to receive the contact information of a salesman when the salesman rudely walks in to the office without an appointment, etc. No one likes to say no. The information relaying apparatus 400 provides the ability to quickly and easily collect personal, business, confidential, rejection/denial, number transfer, and/or business stationary contact information, and the ability to discriminate to or from who contact information is transferred. Therefore, while the information relaying apparatus 400 can be used to transfer and retrieve personal, business, confidential, rejection/denial, number transfer, business stationary, and/or off mode contact information and/or associated subcategory contact information, the apparatus 400 also enables an underlying game that every person on a day to day basis plays, e.g. a yes/no game. The user can preprogram the no mode as if he/she could preprogram the other six modes to give a read out of their intended rejection message. Examples of such messages can include “Sorry, I have a boyfriend already”, “You're sweet anyway!”, or a more abrasive message such as “Get Lost”. They either like you and want you to get to know them or they don't. In a social or business environment this is a tool that allows people to communicate discretely (e.g., not face to face denial). The user has complete control. As described above, the information relaying apparatus 400 can be configured in additional modes as desired.

The information relaying apparatus 400 can be configured with a rejection/denial mode configured to enable a user to choose either a preprogrammed rejection/denial message or one that they can create themselves, such as “Sorry, I'm not interested at this time!”, “Please do not bother me now!”, etc. The information relaying apparatus 400 can be configured with a number transfer mode configured to enable a user easily input and send merely his/her phone number and/or name. The information relaying apparatus 400 can be configured with a business stationary mode configured to enable a user to set up profiles for inputting useful information from indoor/outdoor business stationary devices in their day to day environment.

The information relaying apparatus 400 can be configured with a limited read-out capability. In certain relational encounters between two individuals, it may be awkward and uncomfortable for one user of an information relaying apparatus 400 to know what the other person is sending. It may be a rejection/denial message. The limited read-out capability provides the user with an indication that a transfer or retrieval has been made, and can tally the number of transfers and/or retrievals that have been made. The user will not know what category type of information was received until reconfiguring the information relaying apparatus 400 in another setting. The display screen on an information relaying apparatus 400 configured with the limited read-out capability can be provided with a delay in the form of a cartoon or the layering of commands so the user cannot read what type of information has been received for a predetermined period of time.

The information relaying apparatus 400 can be configured with the ability for multiple contact mode and/or contact mode subcategory transfer and receipt. This enables users to transfer and/or receive multiple contact mode and/or contact mode subcategory of data if they choose to do so. For example, a user can then transfer designated business and personal contact mode and designated business and contact mode subcategory data to another user.

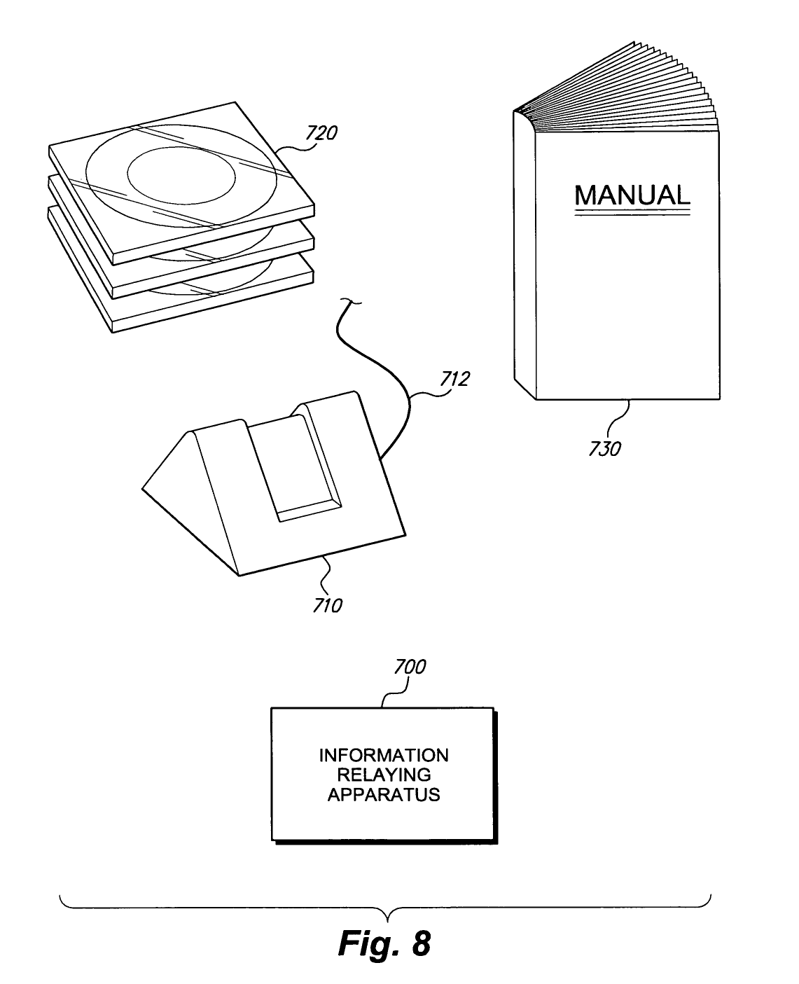

The information relaying apparatus 400 may be provided as a kit, as shown in FIG. 8, including an information relaying apparatus 700, a port/holder 710 configured for interconnecting the information relaying apparatus 700 with a computer arrangement via a cable 712 or other linking arrangement, a computer usable medium 720 with information relaying software modules stored therein, and an operational instruction manual 730 including instructions for operating the information relaying apparatus 700. For example, presume the information relaying apparatus 700 is configured as a cell phone and the computer usable medium 720 is configured as a CD-ROM. Initially, the port/holder 710 would be interconnected to a remote computer device.

The cell phone with information relaying circuitry contained therein would then be attached to the port/holder 710. The CD-ROM 720 would then be loaded into the computer arrangement and the user would enter personal and business contact information via some type of browser or GUI configured for receiving the personal, business, confidential, rejection/denial, number transfer, and/or business stationary contact information. The browser provided by the information relaying software modules contained on the CD-ROM 720 then guides the user during the contact information input process. The CD-ROM 720 can organize and guide the user through the programming process in an extremely user friendly manner. Anyone can do this whether they have a limited knowledge of computers or not.

Once the contact information has been entered and appropriate settings are provided to the cell phone, the cell phone is then operationally configured. Other settings that the user may store in the cell phone include such parameters as proximate distance range, or movement or vibration intensity for when one cell phone is detected by another wristband to cause the cell phone to relay contact information with another information relating apparatus, e.g., another cell phone, and the date or time if so desired. The browser may provide security measures, such as entry of a personal identification number, a password, a user name, etc., before any settings can be changed.

The CD-ROM 720 can be configured to guide the user and help the user to do the following: (1) enable the user to program his/her personal, business, confidential, rejection/denial, number transfer, and/or business stationary contact information and then download this information into the cell phone; (2) enable the user to change their personal, business, confidential, and/or off mode contact information or associated subcategory contact information at any time; (3) provide the user a heads-up response if duplicate personal, business, confidential, and/or off mode and/or associated subcategory contact information has been retrieved from the wristband, such as saving a file that is the same as one that has already been saved; (4) enable the user to upload new personal, business, confidential and/or off mode contact information and/or associated subcategory contact information once retrieved; (5) indicate to the user how many contacts have been retrieved; (6) enable the user to modify or delete data once collected, etc.

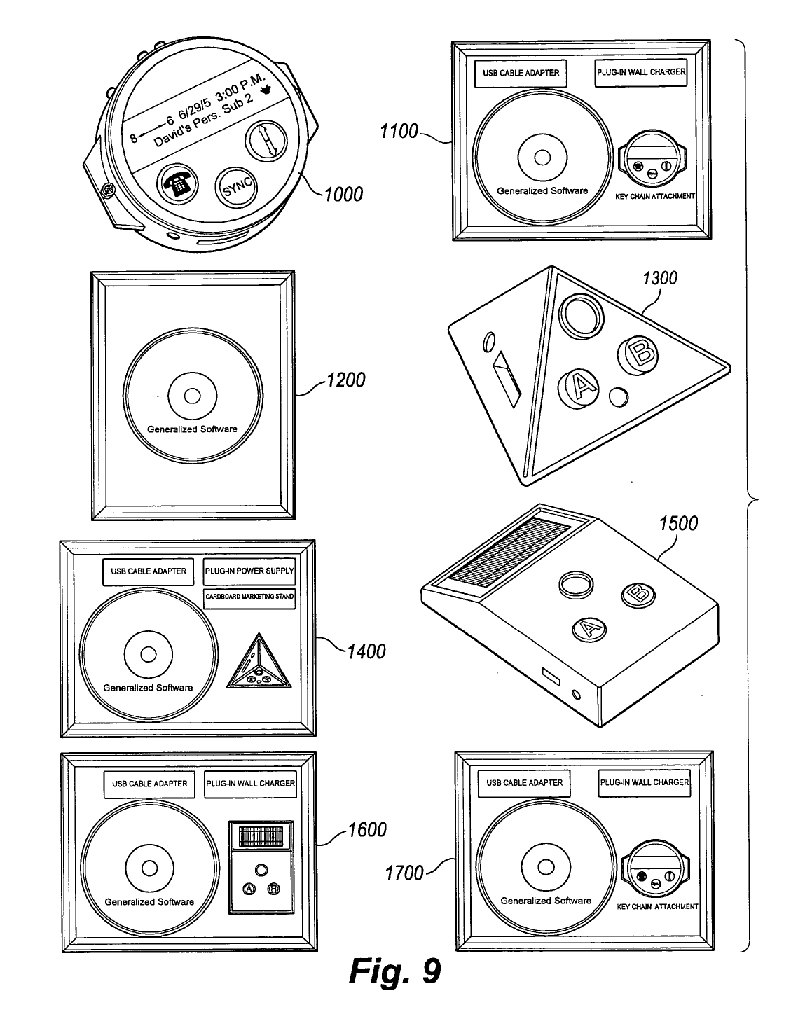

An information relaying system group according to the present invention is shown in FIG. 9. The information relaying system group includes a stand-alone all purpose information relaying device 1000, a stand-alone all-purpose information relaying device kit 1100, a mobile communications device compatible information relaying software CD 1200, an indoor business stationary information relaying device 1300, an indoor business stationary information relaying device kit 1400, an outdoor business stationary information relaying device 1500, an outdoor business stationary information relaying device kit 1600, and a business stand-alone information relaying device kit 1700.

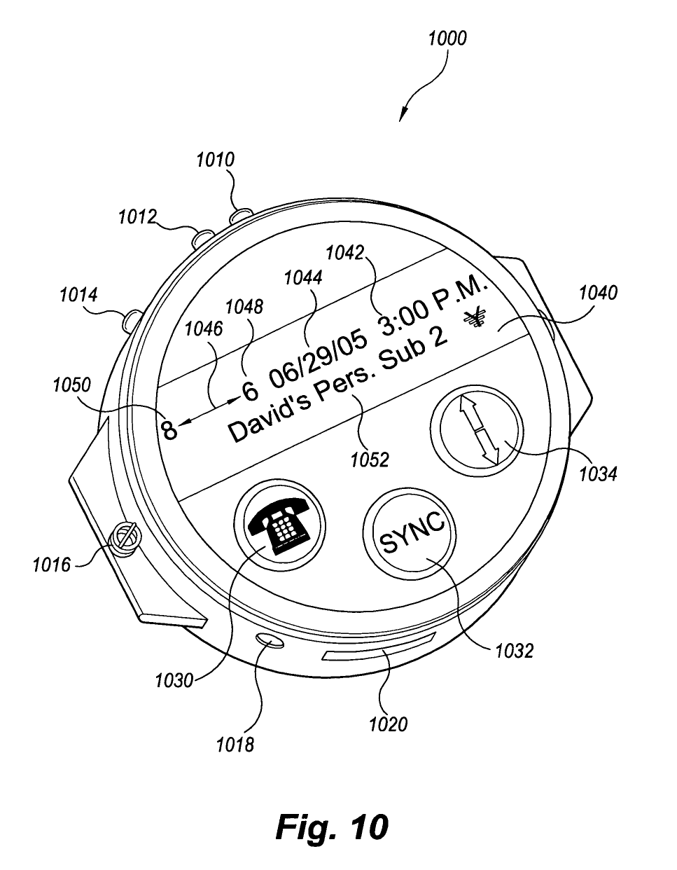

The stand-alone all purpose information relaying device 1000 is shown in FIG. 10. The device 1000 includes features that may include a light 1010, a light 1012, a coupler 1014, a retractable hook 1016, an external charger interface port 1018, a USB interface port 1020, and a retractable hook acceptance eye. The device 1000 includes a home phone number transfer button 1030, a sync button 1032, and a scroll button 1034, and a display screen 1040. The device 1000 can also be configured with a key chain attachment hook to facilitate attaching the device 1000 to a key chain. The home phone number transfer button 1030 enables the user to readily transfer their home phone number to another information relaying apparatus. The sync button 1032 enables the user to send/receive information that displays itself on the display screen. The scroll button 1034 enables the user to select a desired category of information from a variety of categories of information.

Images/data can be presented or displayed on the display screen 1040. For example, the display screen 1040 can show a date element 1044, an indicator 1046 with right and left arrows with a six 1048 on the right that indicates a number of successful incoming communication transfer messages of shared messages, a selected category 1052, a power display, and a time element 1042. The light 1010 can be a green light or LED that becomes active when a communication exchange is occurring. The light 1012 can be a red light or LED that becomes active when a communication exchange has ended. The eight 1050 on the left of the indicator 1046 quantifies the number of successful outgoing communication transfers of shared information have been made. The retractable hook 1016 can be used in conjunction with the retractable hook acceptance eye to fasten the device 1000 to notebooks, purses and/or any other item a person carries around with them.

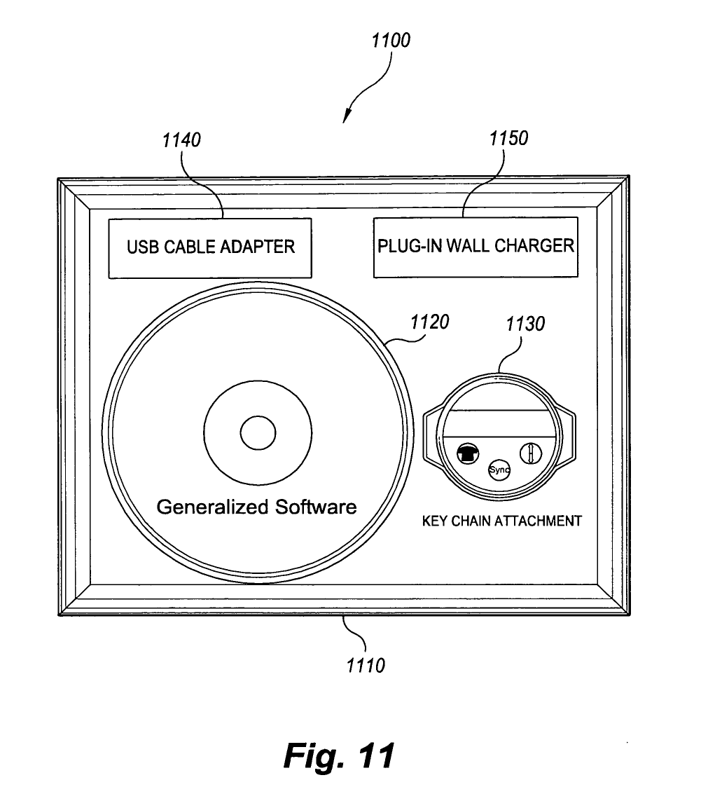

The stand-alone all-purpose information relaying device kit 1100 is shown in FIG. 11. The kit 1100 is configured for users who want a simplistic, trendy, non-cumbersome, inexpensive, push-button controlled device that provides them with the ability to share pre-programmed useful information with other users in their day to day lives. The kit 1100 includes packaging 1110, an information relaying software CD 1120, a stand-alone all-purpose information relaying device 1130, a USB cable adapter 1140, and a plug-in wall charger 1150. The user can load the software on the CD 1120 on any convenient computer device with a USB port or that is configured to be interconnected with a USB cable adapter. The user can then interconnect the device 1130 to the computer device with the USB cable adapter 1140. The plug-in wall charger 1150 can interconnect the device 1130 with wall or other external power source outlet.

The information relaying software CD 1120 carries executable software of any desirable code that is compatible with other database software. The code can be configured in Windows format, Lenox format, MacOsx format, etc. The software can be configured to be controlled through a physical key structure of the information relaying device 1130 or can be controlled by a touch screen interface. The software, once installed on the device 1130, can be configured to send wirelessly to another device 1130 for the purpose of installing itself on the other device 1130. The software can also be provided on an internet website and be operable in that manner. The software provides username/password/device identity, the ability to authenticate users online with a web application, the ability to authenticate users with the device 1130 to preserve integrity and confidentiality of data on the device 1130. The software enables users to create profiles including, but not limited to personal, business, confidential, rejection/denial, number transfer, and business stationary. The software enables users to add photos and attach files to profiles, sort profiles by column heading, and add videos and transfer through profiles.

The software provides users with help menus to assist the user. The software enables users to store created profiles in an industry standard vCard Version 3.0 format (RFC 2425, 2426), and to send profiles over USB/serial connections to other devices 1130 and/or another information relaying apparatus 400. The software can retrieve complete transfer and/or retrieval histories from the device 1130 and/or another information relaying apparatus 400. The software can store histories of profiles sent to and received from the device 1130 and/or another information relaying apparatus 400. The software can display a history of profiles in an easily readable format for book keeping and non-repudiation. The software can transfer received profiles from the device 1130 and/or another information relaying apparatus 400. The software can email retrieved and/or transferred profiles, display profile information. The software can recognize which device 1130 or other information relaying apparatus 400 has been plugged into the USB cable connection, and can determine which direction to send the user information.

The software operates on an application layer protocol that is configured to facilitate the transmission of data between device 1130 or other information relaying apparatuses 400 using the IrDA communication standard or other communication methodologies. The application layer protocol can readily interact with various network transport technologies (e.g., Bluetooth, TCP/IP, etc.). The software transports information in modes including, but not limited to, format enhanced information transmission mode, link reference transmission mode, file transmission mode, contact information transmission mode, application transmission mode, and transaction object bi-directional message exchange mode.

The format enhanced information transmission mode provides the ability to transfer useful information containing a broad spectrum of contact information including all well known data in the universal vCard format, plus additional information such as photos, personalized messages, video streaming, etc. These fields enhance typical data found in other software applications. The link reference transmission mode provides transfer of OBEX data objects containing URL references to files that can be obtained via the internet from an information relaying server for a predetermined transaction fee. The link reference transmission mode provides a small link to a much larger data object, such as a large image, a slideshow presentation, etc. The file transmission mode provides the ability to transfer an arbitrary file of an arbitrary length. The file transmission mode provides a way to distribute files as easily as using a thumb-drive, only better because it enables file transfer without the use of an intervening computer.

The contact information transmission mode provides vCard format for backward compatibility. Most hand-held devices such as PDAs and cell phones are currently able to exchange contact information universally utilizing the vCard format. For backward compatibility, the contact information transmission mode can send and/or receive contact vCard data just as all other devices are able to do. Such data is not intended to contain information such as images and documents. The application transmission mode provides the ability to transmit application files to PDAs in a PRC format. Transmitted data is intended to be recognized by a PDA as an incoming received application. Such users can then install the received file and have a functioning information relaying application on that PDA. The transaction object bi-directional message exchange mode provides a mechanism to confirm success and/or failure of a transmission with no errors between two synching users of devices 1130 or other information relaying apparatuses 400. Such messaging transactions enable the transfer or trading of tokenized electronic commodities. The transfer of money is one example of this.

The executable software that provides a welcoming screen for the user and can recognize the interconnected type of device 1130. The executable software provides logins for the user to enter a login user name, a password, etc. The executable software provides a main all-purpose platform screen with categories including personal, business, confidential, rejection/denial (marketing hook), number transfer (marketing hook), and/or business stationary. The executable software enables the user to create various profiles on the computer device in an extremely user-friendly manner. The executable software enables the user to download such created profiles from the computer device into the device 1130. The device 1130 may include any desired components of information relaying circuitry for an information relaying apparatus 400 previously discussed.

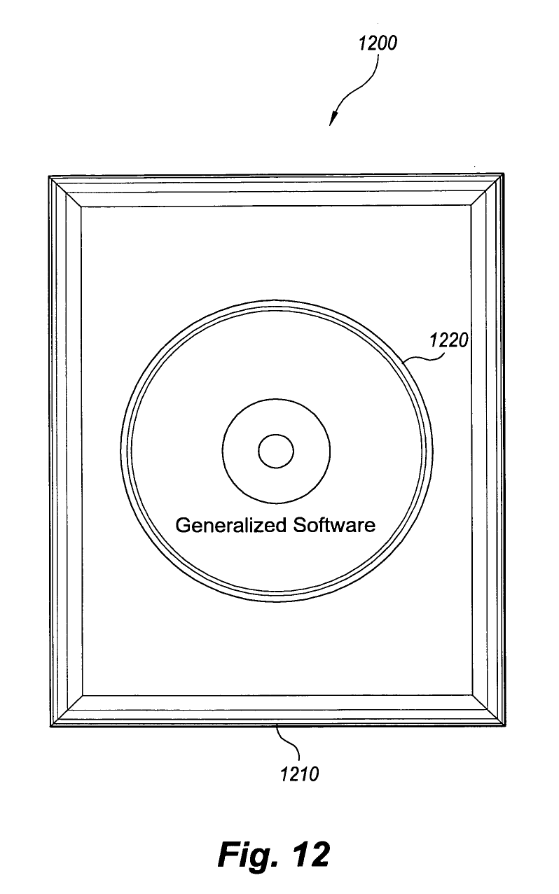

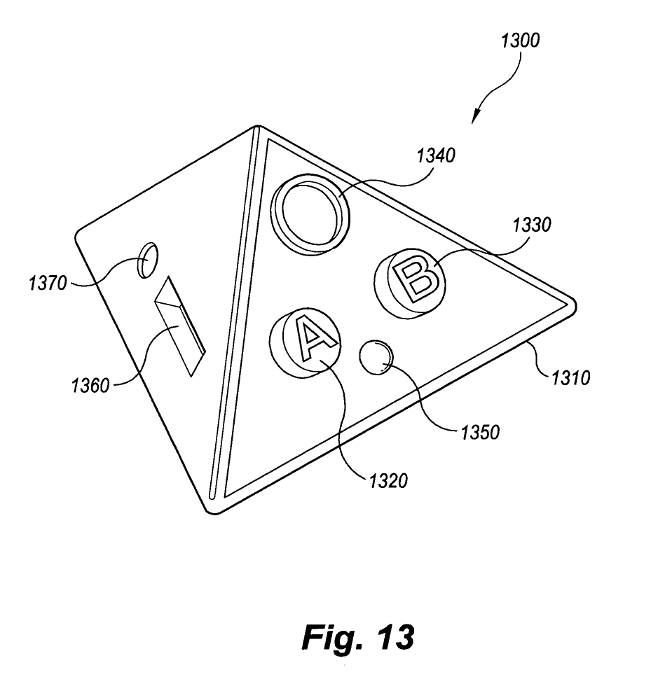

The mobile communications device compatible information relaying software CD 1200 is shown in FIG. 12. The CD 1200 carries the same executable software that was previously described for the information relaying software CD 1120 in the stand-alone all-purpose information relaying device kit 1100. The indoor business stationary information relaying device 1300 is shown in FIG. 13. The device 1300 is configured for suitable ease of manufacturing, pleasing aesthetical and functional design and economical in nature. The device 1300 is shaped to avoid tipping over by a stiff cable connection, touching from a person, etc. The illustrated shape is a pyramid with a weighted base with buttons used to allow a user to give his/her information to the device 1300. The device 1300 includes a housing 1310, button 1320, button 1330, an infrared sensing element 1340, an inductive coupling 1350, a USB cable adapter acceptance port 1360, and a plug-in power supply acceptance port 1370. The buttons 1320 and 1330, the number of which can vary, enable a user to exchange useful information with the device 1300. The device 1300 may include any desired components of information relaying circuitry for an information relaying apparatus 400 previously discussed.

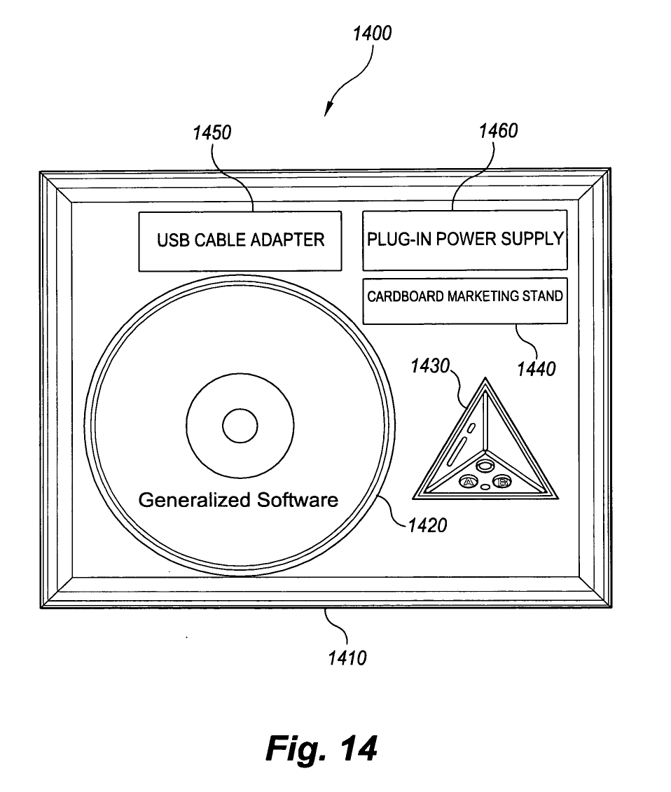

The indoor business stationary information relaying device kit 1400 is shown in FIG. 14. The kit 1400 includes packaging 1410, an information relaying software CD 1420, an indoor business stationary information relaying device 1430, a marketing stand 1440, a USB cable adapter 1450, and a plug-in power supply 1460. The CD 1420 carries the same executable software that was previously described for the information relaying software CD 1120 in the stand-alone all-purpose information relaying device kit 1100. The user can load the software on the CD 1420 on any convenient computer device with a USB port or that is configured to be interconnected with a USB cable adapter. The user can then interconnect the device 1430 to the computer device with the USB cable adapter 1450. The plug-in power supply 1650 can interconnect the device 1430 with a wall or other external power source outlet. The marketing stand 1440 can be used to mount marketable items at a desired business location. The device 1430 may include any desired components of information relaying circuitry for an information relaying apparatus 400 previously discussed.

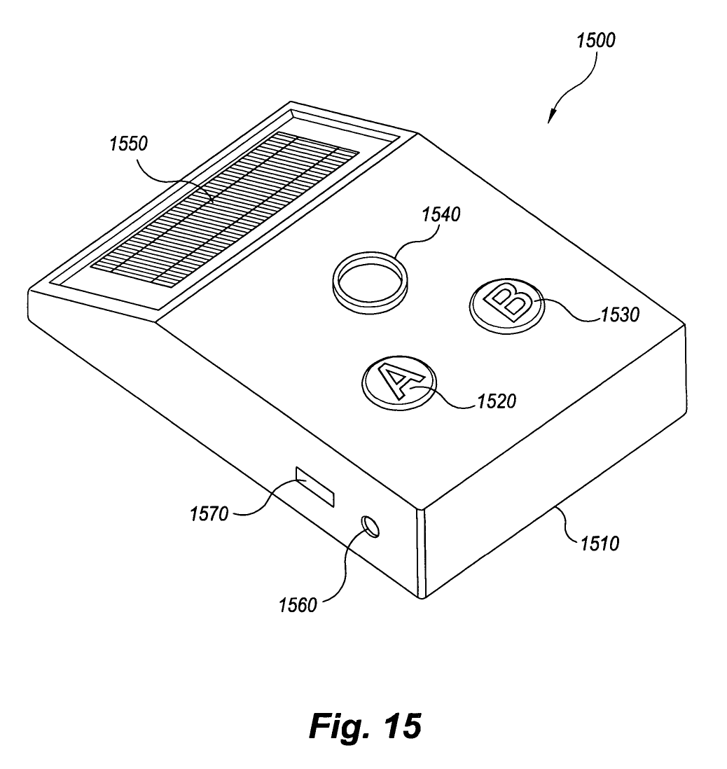

The outdoor business stationary information relaying device 1500 is shown in FIG. 15. The device 1500 is configured for suitable ease of manufacturing, pleasing aesthetical and functional design and economical in nature. The device 1500 is ruggedized and shaped to maintain stability from tipping over by any outside forces. The device 1500 includes a housing 1510 which is weather resistant, can facilitate mounting by hanging on hooks, and can be clamped or secured on the side or bottom. The device 1500 includes button 1520, button 1530, an infrared sensing element 1540, a solar cell power supplier 1550, a plug-in power supply acceptance port 1560, and a USB cable adapter acceptance port 1570. The buttons 1520 and 1530, the number of which can vary, enable a user to exchange useful information with the device 1500. The device 1500 may include any desired components of information relaying circuitry for an information relaying apparatus 400 previously discussed. The information relaying circuitry is configured to tolerate some presence of moisture and be weather resistant.

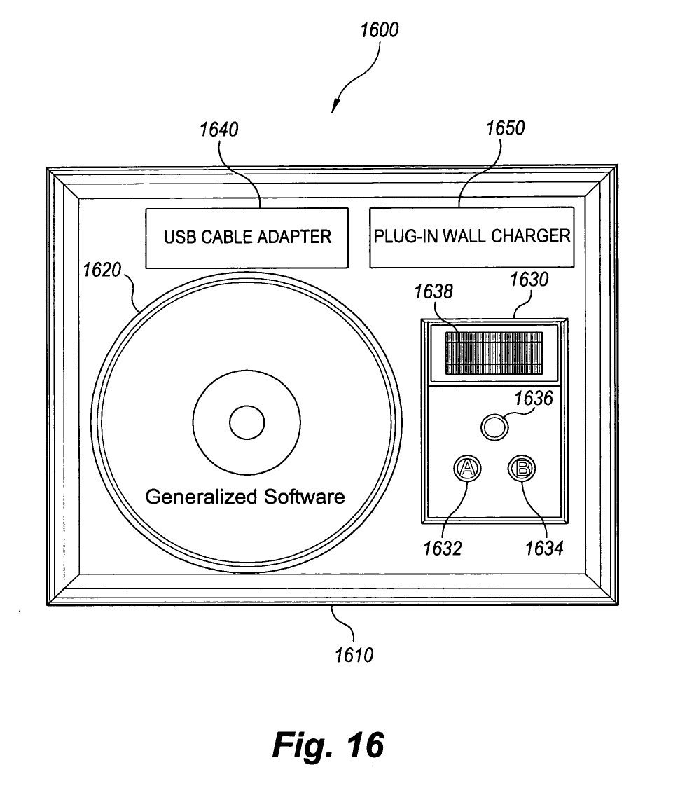

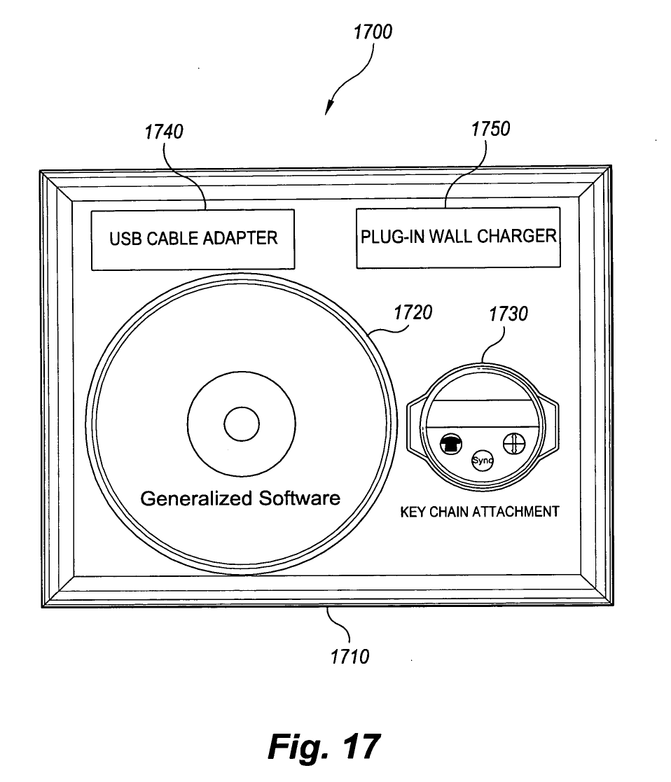

The outdoor business stationary information relaying device kit 1600 is shown in FIG. 16. The kit 1600 includes packaging 1610, an information relaying software CD 1620, an indoor business stationary information relaying device 1630, a USB cable adapter 1640, and a plug-in wall charger 1650. The CD 1620 carries the same executable software that was previously described for the information relaying software CD 1120 in the stand-alone all-purpose information relaying device kit 1100. The user can load the software on the CD 1620 on any convenient computer device with a USB port or that is configured to be interconnected with a USB cable adapter. The user can then interconnect the device 1630 to the computer device with the USB cable adapter 1640. The device 1630 is configured as the outdoor business stationary information relaying device 1500 of FIG. 15, and includes button 1632, button 1534, an infrared sensing element, a solar cell power supplier 1638, a plug-in power supply acceptance port, and a USB cable adapter acceptance port. The plug-in wall charger 1650 can interconnect the device 1630 with a wall or other external power source outlet. The device 1630 may include any desired components of information relaying circuitry for an information relaying apparatus 400 previously discussed.

The outdoor business stand-alone information relaying device kit 1600 is shown in FIG. 16. The kit 1600 includes packaging 1610, an information relaying software CD 1620, an outdoor business stand-alone information relaying device 1730, a USB cable adapter 1740, and a plug-in wall charger 1750. The CD 1720 carries the same executable software that was previously described for the information relaying software CD 1120 in the stand-alone all-purpose information relaying device kit 1100. The user can load the software on the CD 1720 on any convenient computer device with a USB port or that is configured to be interconnected with a USB cable adapter. The user can then interconnect the device 1730 to the computer device with the USB cable adapter 1740. The device 1730 is configured as the stand-alone all-purpose information relaying device 1130 of FIG. 9. The plug-in wall charger 1750 can interconnect the device 1730 with a wall or other external power source outlet. The device 1730 may include any desired components of information relaying circuitry for an information relaying apparatus 400 previously discussed.

In today's market, a set of about two hundred business cards can cost about $80.00. Once such cards are received, the damage is done because if there is the slightest change, such as if a new cell number has been established, the cards are all messed up. The information relaying apparatus 400 can eliminate such a problem because the user can simply change as they go (e.g., every minute, hour, or day). There is no longer a need to print business cards.

While the invention has been described with references to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

We claim:

1. An information relaying method comprising:
providing an information relaying website, information relaying software, and an information relaying database;
providing information relaying apparatuses to users;
establishing communication links between particular users of the information relaying apparatuses;
selecting at least one mode selected from the group consisting of a personal contact mode, a business contact mode, a confidential contact mode, a rejection/denial contact mode, a number transfer contact mode, and a business stationary contact mode, and an off mode to operate the information relaying apparatuses of the particular users;
operating the information relaying apparatuses of the particular users according to the associated selected at least one mode; and
relaying contact information over the established communication links between the particular users of the information relaying apparatuses according to the associated selected at least one mode.

2. The information relaying method according to claim 1, further comprising:
providing username/password/device identity;
authenticating users online with a web application;
authenticating users with one of the apparatuses to preserve integrity and confidentiality of data on the one apparatus; and
creating profiles including personal, business, confidential, rejection/denial, number transfer, and business stationary.

3. The information relaying method according to claim 1, further comprising:
adding photos and attaching files to profiles;
sorting profiles by column heading; and
adding videos and transferring through profiles.

4. The information relaying method according to claim 1, further comprising:
establishing a limited screen read-out to enable a user to cause the receiving party's information relaying apparatus to read limited information at a time of contact information transfer.

5. The information relaying method according to claim 1, further comprising:
operating on an application layer protocol that is configured to facilitate the transmission of data between the information relaying apparatus and another information relaying apparatus; and
transporting information from the information relaying apparatus to another information relaying apparatus in modes including format enhanced information transmission mode, link reference transmission mode, file transmission mode, contact information transmission mode, application transmission mode, and transaction object bi-directional message exchange mode.

6. An information relaying apparatus for relaying contact information between users comprising:
a power source;
memory with information relaying software embodied therein;
a processor;
a clock;
at least one sensor;
at least one transceiver;
an antenna, and
a communication bus electrically interconnecting the power source, memory, the processor, the clock, the at least one sensor, the at least one transceiver, and the antenna,
wherein said information relaying software, when executed by the processor, causes the processor to carry out the steps comprising:
establishing a communication link between the user of the information relaying apparatus and a user of another information relaying apparatus;
selecting at least one mode selected from the group consisting of a personal contact mode, a business contact mode, a confidential contact mode, a rejection/denial contact mode, a number transfer contact mode, and a business stationary contact mode, and an off mode to operate the information relaying apparatus of the user;
operating the information relaying apparatuses of the user according to the selected at least one mode; and
relaying contact information over the established communication link between the user of the information relaying apparatus and the other user of an information relaying apparatus according to the associated selected at least one mode.

7. The information relaying apparatus according to claim 6, further comprising:
at least one visual indicator;
at least one audible indicator;
at least one physical indicator;
at least one display;
at least one modem;
at least one input/output interface; and
at least one input/output port.

8. The information relaying apparatus according to claim 6, wherein said information relaying software, when executed by the processor, causes the processor to further carry out the steps comprising:
providing username/password/device identity;
authenticating users online with a web application;
authenticating users with the apparatus to preserve integrity and confidentiality of data on the apparatus; and
creating profiles including personal, business, confidential, rejection/denial, number transfer, and business stationary.

9. The information relaying apparatus according to claim 6, wherein said information relaying software, when executed by the processor, causes the processor to further carry out the steps comprising:
adding photos and attaching files to profiles;
sorting profiles by column heading; and
adding videos and transferring through profiles.

10. The information relaying apparatus according to claim 6, wherein said information relaying software, when executed by the processor, causes the processor to further carry out the steps comprising:
establishing a limited screen read-out to enable a user to cause the receiving party's information relaying apparatus to read limited information at a time of contact information transfer.

11. The information relaying apparatus according to claim 6, wherein said information relaying software, when executed by the processor, causes the processor to further carry out the steps comprising:
operating on an application layer protocol that is configured to facilitate the transmission of data between the information relaying apparatus and another information relaying apparatus; and
transporting information from the information relaying apparatus to another information relaying apparatus in modes including format enhanced information transmission mode, link reference transmission mode, file transmission mode, contact information transmission mode, application transmission mode, and transaction object bi-directional message exchange mode.

12. The information relaying apparatus according to claim 6, wherein said information relaying apparatus is configured in a kit comprising:
packaging;
an information relaying software CD;
a USB cable adapter; and
a plug-in wall charger.

13. The information relaying apparatus according to claim 6, wherein said information relaying apparatus is a stand-alone all-purpose information relaying device and said kit is a stand-alone all-purpose information relaying device kit.

14. The information relaying apparatus according to claim 6, wherein said stand-alone all-purpose information relaying device further comprises:
a home phone number transfer button;
a sync button; and a scroll button; and
a display screen,
wherein the home phone number transfer button enables a user to readily transfer their home phone number to another information relaying apparatus, said sync button enables a user to send/receive information that displays itself on the display screen, and said scroll button enables a user to select a desired category of information from a variety of categories of information.

15. The information relaying apparatus according to claim 6, wherein said information relaying apparatus is an indoor business stationary information relaying device and said kit is an indoor business stationary information relaying device kit.

16. The information relaying apparatus according to claim 6, wherein said an indoor business stationary information relaying device kit further comprises a marketing stand.

17. The information relaying apparatus according to claim 6, wherein said information relaying apparatus is an outdoor business stationary information relaying device and said kit is an outdoor business stationary information relaying device kit.

18. The information relaying apparatus according to claim 6, wherein said information relaying apparatus is a business stand-alone information relaying device and said kit is a business stand-alone information relaying device kit.

19. A computer program product comprising a computer readable media with executable instructions that carry out steps comprising:
establishing a communication link between the user of the information relaying apparatus and a user of another information relaying apparatus;
selecting at least one mode selected from the group consisting of a personal contact mode, a business contact mode, a confidential contact mode, a rejection/denial contact mode, a number transfer contact mode, and a business stationary contact mode, and an off mode to operate the information relaying apparatus of the user;
operating the information relaying apparatuses of the user according to the selected at least one mode; and
relaying contact information over the established communication link between the user of the information relaying apparatus and the other user of an information relaying apparatus according to the associated selected at least one mode.

20. The computer program product according to claim 19, wherein the executable instructions further carry out the steps comprising:
providing username/password/device identity;
authenticating users online with a web application;
authenticating users with the apparatus to preserve integrity and confidentiality of data on the apparatus; and
creating profiles including personal, business, confidential, rejection/denial, number transfer, and business stationary.

21. The computer program product according to claim 19, wherein the executable instructions further carry out the steps comprising:
adding photos and attaching files to profiles;
sorting profiles by column heading; and
adding videos and transferring through profiles.

22. The computer program product according to claim 19, wherein the executable instructions further carry out the steps comprising:
establishing a limited screen read-out to enable a user to cause the receiving party's information relaying apparatus to read limited information at a time of contact information transfer.

23. The computer program product according to claim 19, wherein the executable instructions further carry out the steps comprising:
operating on an application layer protocol that is configured to facilitate the transmission of data between the information relaying apparatus and another information relaying apparatus; and
transporting information from the information relaying apparatus to another information relaying apparatus in modes including format enhanced information transmission mode, link reference transmission mode, file transmission mode, contact information transmission mode, application transmission mode, and transaction object bi-directional message exchange mode.
